(19) United States
(12) Patent Application Publication
(10) Pub. No.: US 2012/0179516 A1
(43) Pub. Date: Jul. 12, 2012

(54) SYSTEM AND METHOD FOR COLLECTIVE AND GROUP DISCOUNT PROCESSING MANAGEMENT

(76) Inventors: Delaram Fakhrai, Laguna Beach, CA (US); Mehran Moshfeghi, Rancho Palos Verdes, CA (US)

(21) Appl. No.: 13/346,702

(22) Filed: Jan. 9, 2012

Related U.S. Application Data
(60) Provisional application No. 61/430,956, filed on Jan. 7, 2011.

(51) Int. Cl. G06Q 30/02; G06Q 30/08

(52) U.S. Cl. 705/14.1; 705/26.3

(57) ABSTRACT

Discount processing auction methods and systems are provided where buyers pool their purchasing power in order to get more competitive offers from sellers. Instead of sellers directly bidding for the buyer's shopping lists, the sellers update their discount rules and a discount processing method processes the sellers' latest discount rules and presents the results to the buyers while the auction is active. Buyers dynamically form a group and invite others to join the group to increase their purchasing power and maximize the discounts. Customers can form a social network with other buyers to share wish-lists, shopping carts, and discount scenarios. Consumers who commit to buy a total number of items over a period of time increase their effective purchasing power across time. Sellers also group together to offer higher total discount on a combination of items to buyers.

### CLAIM OF BENEFIT TO PRIOR APPLICATIONS

The present application claims the benefit of U.S. Provisional Patent Application 61/430,956 entitled, “Method for Collective and Group Discount Processing Management,” filed Jan. 7, 2011. The contents of U.S. Provisional application 61/430,956 are hereby incorporated by reference.

### BACKGROUND

Consumers who want to buy products are interested in getting the best deals. The traditional method used by sellers has been to give discount coupons to buyers. More recently companies such as Priceline.com have allowed a buyer of vacation items such as airlines tickets, hotel rooms, and cars to specify a maximum price and as long as Priceline.com meets or lowers that price the buyer is obligated to purchase the product. This approach, however, does not allow for pooling of multiple buyers to reduce the purchase price with bidding from multiple sellers.

There are companies (such as Groupon™) that market deals from producers/retailers and as long as a minimum number of buyers commit to the deal then the deal is offered to the buyers. However, there is no bidding by different producers and the price of the deal is set beforehand by the producer/retailer. There are also reverse auction companies where the roles of buyers and sellers are reversed and sellers compete to obtain the business of a seller. However, reverse auction sites do not allow the pooling of multiple buyers.

### BRIEF SUMMARY

Some embodiments provide a discount processing auction method where buyers pool their purchasing power in order to get more competitive offers from product manufacturers (producers), distributers/retailers, and shipping companies (collectively called sellers). Instead of sellers directly bidding for the buyer's shopping lists (as is the case in a traditional reverse auction) the sellers update their discount rules and a discount processing method processes their latest discount rules and presents the results to the buyers while the auction is active. Thus, the sellers indirectly bid (by updating their discount rules) on a pooled group of buyers.

This method has several benefits. For buyers it provides a way to get the best deals on their shopping lists. For product manufacturers, retailers, and shipping companies it offers new channels of potentially new customers and higher sales volume. Advertisers can also use the discount processing auction site and server to target relevant advertisements to the buyers. There are several unique aspects of this method as described in the following paragraphs.

Buying customers can dynamically form a group and invite others to join the group to increase their purchasing power across buyers and maximize the discounts. These customers can form a social network with friends (or other buyers) to share wish-lists, shopping carts, and discount scenarios. Consumers can commit to buy a total number of items over a period of time, thereby increasing their effective purchasing power across time. The buyer still buys the same items he/she would otherwise, but he/she tells the system in advance by committing to the purchases in order to receive wholesale discounts. A buyer's account can have multiple members who can access and modify the wish list of shopping items. This is useful for families and businesses.

Retailers and producers can update and tag their discount items/rules with time and location constraints. This allows the discount processing auction site to take into account the location of the buyer and analyze discount scenarios that are not only optimal by price but also minimize the distance of the seller from the buyer in the case of brick and mortar applications. Furthermore, retailers can define different discounts for the same item at different store locations and at different times.

A group of retailers/producers can group together to offer higher total discount on a “combination of items” in a buyer's wish-list or cart items. Grouping of sellers can be initiated by the sellers (e.g., sellers with complementary products can form seller groups) or can be analyzed and suggested by the system (e.g., by the statistics of items in all potential buyers' carts).

The discounts for the buyer can be direct discount for purchase price, reward points, or rebate cash-backs. The discounts are offered by producers, retailers, shipping companies, or a combination of them. Replacement suggestions are provided to buyers (to replace an item with a similar or slightly different item) in exchange for higher wholesale/group discounts. The purchasing profile/trend/history of buyers is used to analyze and suggest wholesale/group discount opportunities to both buyers and sellers.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matters are not to be limited by the illustrative details in the Summary, Detailed Description and the Drawing, but rather are to be defined by the appended claims, because the claimed subject matters can be embodied in other specific forms without departing from the spirit of the subject matters.

### BRIEF DESCRIPTION OF THE DRAWINGS

The novel features of the invention are set forth in the appended claims. However, for purpose of explanation, several embodiments of the invention are set forth in the following figures.

FIG. 1 conceptually illustrates an overview of an online discount processing auction system in some embodiments of the invention.

FIG. 2 conceptually illustrates a process for the interaction of a brick and mortar retail seller with the discount processing auction site in some embodiments of the invention.

FIG. 3 conceptually illustrates a process performed at an auction site for the interaction of a buyer with the discount processing of auction site in some embodiments of the invention.

FIG. 4 conceptually illustrates examples of the information elements associated with a product that are stored in different databases in some embodiments of the invention.

FIG. 5 conceptually illustrates a sample producer database storing discount items and rules for a producer in some embodiments of the invention.

FIG. 6 conceptually illustrates a sample retailer database storing discount items and rules for a retailer in some embodiments of the invention.

FIG. 7 conceptually illustrates example of the information that a buyer enters into a shopping cart in some embodiments of the invention.

FIG. 8 conceptually illustrates an example of a process for applicable discount scenarios and suggestions presented to a buyer in some embodiments of the invention.

FIG. 9 conceptually illustrates a process for making payments for a shopping/wish list through a mobile device in some embodiments of the invention.

FIG. 10 conceptually illustrates a process performed by mobile devices of customers to enable the customers to use their mobile devices to scan items and pay for them in-store and bypass the in-store cashier in some embodiments of the invention.

FIG. 11 conceptually illustrates an electronic system with which some embodiments of the invention are implemented in some embodiments of the invention.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments of the invention provide discount processing and management systems and methods where i) retailers, producers, and shippers separately or jointly enter their discount items and rules for single, wholesale, and group discounting scenarios, ii) buyers enter their cart items to receive highest discount offers from multiple retailers/producers or enter their wish-items with a price limit, iii) buying customers dynamically form a group and invite others to join the group to increase their purchasing power across buyers and maximize the discounts, iv) a single buyer receives wholesale discount by committing to purchase a large number of items over a period of time or by committing to purchase a total sum from the same retailer/producer over a period of time (increasing purchasing power across time); the system delivers higher discounts to individual buyers through a wholesale discounting mechanism where a buyer commits future purchases from a retailer or producer in exchange for additional discount, v) the discount processor analyzes group discounting rules by retailers/producers and identifies and optimizes group discounting scenarios by suggesting group discounts to buyers, vi) the system allows for sellers to form groups to offer more competitive overall discount on a buyers' total wish/shopping items, and vii) the system identifies seller grouping opportunities and suggests them to those sellers.

Sellers in some embodiments enter their discounted items and rules for single, wholesale, group discounting as a function of several parameters such as customer's location, store's location, purchase time, and purchase commitment time. A group of retailers and producers group together to offer higher total discount on a “combination of items” in a buyer's wish-list or cart items in some embodiments. Sellers in some embodiments utilize the system and its databases to search for suitable seller grouping partners based on product offerings (e.g., other sellers that offer complementary products), geographical location (e.g., neighbor businesses), and product categories.

A replacement and suggestion engine is deployed to analyze customer's wish/cart items against the discounted items and rules by all retailers and producers. The replacement and suggestion engine then suggests replacement items to customers that may increase customers' overall single/wholesale/group discount. The replacement and suggestion engine is utilized in some embodiments for suggesting replacements based on other criterions than just final price such as suggesting healthier/organic replacement for a grocery item in exchange for higher discount percentage (and not necessarily lower final price). The sellers instruct the suggestion engine in some embodiments to replace a competitor's item in a buyer's list with their similar products in exchange for more aggressive discounting. Customers' purchasing history/trends/profiles (for both wish-lists and carts) are analyzed in some embodiments for suggesting replacement items based on these profiles, suggesting grouping with other customers for higher group discounts.

Multiple members of the same “buyer account” are allowed to modify and make changes to a wish-list or cart in some embodiments. The system keeps track of which member has added or modified an item. Once a member makes modifications to the wish-list or cart, the updated data is pushed to all devices of other members of the same “buyer account”. The product in buyers' wish-lists or carts can be a gift-cart (e.g., a gift-card for purchasing $100 worth of products offered at discounted price of $80).

Some embodiments allow buyers to initiate a group or expand a group by inviting friends or other buyers with common purchasing profiles. Some embodiments analyze group discounting rules by retailers/producers and suggest group discounts to buyers. The system allows buyers to differentiate and tag an item as a wish-item or a shopping-item. For wish items a wish-price is provided by the buyer. For shopping items, the buyer does not set a price and the system finds the lowest price or highest discount.

A group/wholesale discount emulator engine is deployed in some embodiments where a buyer simulates the wholesale/group discount scenarios as a function of several parameters such as the number of items, total purchase amount, and size of a group. Different embodiments manage discounts in different forms, including direct discount at checkout, rebate payments, accumulated cash-back, reward points that can be used for future purchases.

An advertisement delivery system for targeted advertisement is deployed in some embodiments. The advertisement delivery system utilizes the information such as buyer's current wish-list and cart, purchase history, current and past locations, the groups the buyer is a member of, and purchasing profile/trend (e.g., whether a buyer usually goes for healthy items, organic items, cheapest items, certain brands, etc.) for targeted advertisement delivery.

Some embodiments keep track of locations of all members of a single buyer account whenever they are on a device with positioning capability. This information is used to deliver discounts based on the combined locations of members. For example, a physical store close to any member of a buyer's account is considered for discount offering.

Retailers and producers dynamically update their corresponding database for discount items/rules based on their latest inventory at different stores/warehouses and expiration dates on applicable items in some embodiments. Some embodiments allow retailers and producers to set special discount rules for displacing a competitor's item in buyers' wish-lists or carts.

For wish-items being entered by a potential buyer, some embodiments conduct an analysis to suggest a reasonable price-range for the item based on data available on the Internet, prices used by other buyers with that item in their wish-list, and the status of any active ongoing reserve-bid on that item. The discounting engine encourages buyers to set realistic and reasonable wish prices for their wish items. If the original wish price of a buyer is met at the end of a bidding process by group discounting mechanism, additional rewards are granted to that buyer. The replacement suggestion method analyzes multiple active current groups (each with already large numbers of buyers) for possible merging of similar groups for even bigger group discounts. Some embodiments maximize the overall combined discounts by a retailer/producer combination (physical store case), or by a retailer/producer/shipper combination (online store case).

When a buyer enters a shopping cart (e.g., grocery items) and receives discounts/coupons on certain items in the list, and visits a store and completes the purchase, the store then uploads the final purchase list to the proposed system and into that buyer's database.

Some embodiments provide social networking capability where buyers interact with other buyers, share wish-lists and carts, share discount scenarios, initiate groups and expand existing groups, search for buyers with common purchasing profiles, post and review comments from other buyers, and others. The product in wish lists or carts can be travel/vacation packages, hotel rooms, airline tickets, car rentals, etc. Some embodiments utilize social networking to allow for buyers in a group (based on the fact that they have purchased a common item such as a car, travel package, etc.) to continue interactions after the purchase event. The buyers can use the system to continue to exchange product problems, comments, experiences, etc.

Some embodiments utilize information stored in databases and interface to buyers and retailers/producers (and their unique identifications) to allow for buyers to confirm and pay for their purchases through their mobile devices and bypass direct use of their credit cards per transaction. Some embodiments utilize information stored in databases and interface to buyers and retailers (and their unique identifications) to allow for buyers to use their mobile devices to scan for items and pay for them by bypassing the in-store cashiers all together.

Several more embodiments are described in the following sections.

### I. Overview

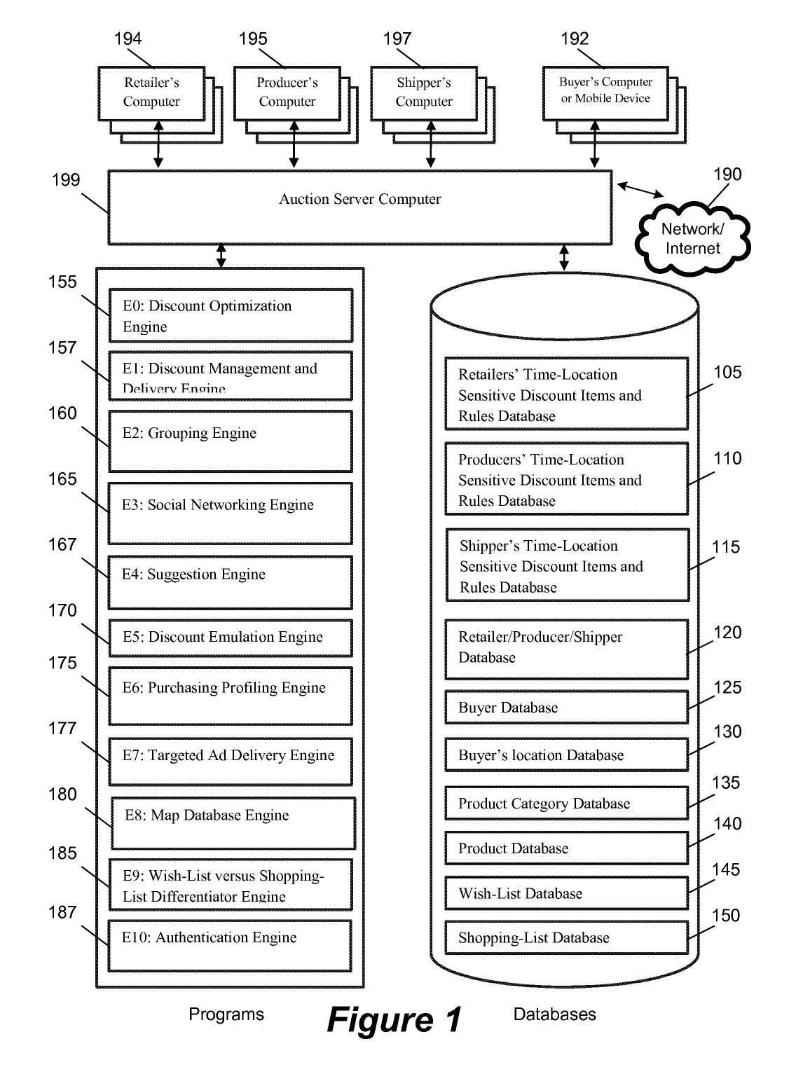

FIG. 1 conceptually illustrates an overview of an online discount processing auction system in some embodiments of the invention. The system uses a network 190 such as the Internet to connect buyers 192 with retailers 194, producers 195, and shippers 197. Potential buyers use their computing devices or mobile devices 192 to interact with the system. The discount processing auction system uses a server computer 199 (or server computers) that run certain programs. The discount processing auction server computer is also networked with databases 105-150 that contain information about buyers, sellers (retailers, producers, shippers, etc.), and products. The discount processing auction server 199 (i) analyzes the data in the databases of buyers, retailers, producers, and shippers, (ii) calculates discount values and scenarios, and (iii) presents them to a buyer or group of buyers (in group discount scenarios).

Although the system and the associated databases and modules are described by using retailers, producers, and shippers as examples of sellers, the term seller refers to any other seller such as manufacturers, growers, assemblers, wholesalers, middlepersons, dealers, etc., in the supply chain. Similarly, the term buyer not only refers to retail buyers, it also refers to any entity that purchases merchandise and services throughout the supply chain. For instance, a wholesaler might act as buyer when dealing with manufacturers but act as a seller when dealing with retailers.

This specification refers to single, wholesale, buyer-group, and seller-group scenarios and discount rules. A single scenario refers to the case where there is a single buyer looking for items to buy. A wholesale scenario refers to a single buyer who is interested in or commits to buying a large number of items or large sum amount over a specific time period. A buyer-group scenario refers to the case where there is a group of buyers looking for common items or a large dollar amount to buy. A seller-group scenario refers to the case where a group of sellers offer a combined discount on multiple items in a buyer's or buyers' list.

This specification also, for clarity, refers to “wish-list” and “shopping cart/list” scenarios. A “wish-list” scenario refers to the case where a buyer sets a wish-price for an item and is only interested or committed to purchase that item at below that wish-price. A “shopping list” refers to the case where a buyer enters a list of items that the buyer is determined to purchase within a time limit but is interested at getting the lowest price or best discount. However, all processes, scenarios, and methods disclosed by referencing to wish lists are equally applicable to shopping lists (or shopping carts). Similarly, all processes, scenarios, and methods disclosed by referencing to shopping lists (or shopping carts) are equally applicable to wish lists. The wish lists and shopping lists are simply purchase lists or buying lists that enumerate what a user or buyer likes to buy. It will be clear and apparent to one skilled in the art that the disclosure of the invention is interchangeable for wish lists, shopping lists, and shopping carts.

The term discount processor refers to combination of hardware processors, servers, and software that manages/analyzes/processes all available bidding/discount rules/policies. The term auction site refers to the online interface used by the discount processor to interface with buyers and seller.

A. Databases and Tables

FIG. 1 shows several databases (or tables) 105-150. The databases contain information about buyers, sellers, and products in some embodiments of the invention.

1. Retailer's Time-Location Sensitive Discount Items and Rules Database

The “Retailer's Time-Location Sensitive Discount Items and Rules” database 105 includes all discounted items by retailers as a function of location and time. The discount items and rules include single, wholesale, and group discount items and rules. Each registered retailer updates this database in order to reflect new store rules or to be more competitive in the auction. For instance, a retailer can offer different discounts at different store locations and with different expiration periods.

Furthermore, a retailer in some embodiments defines and sets discount rules for wholesale and group discounts on specific items or total purchases by buyers. For example, a retailer in some embodiments sets rules to offer special discounts if (a) a customer purchases a certain volume of item A over a period of time, T, (b) a customer purchases a total combined amount of value (e.g., $B) from retailer's stores over a period of T (week, month, year), and (c) a group of customers together purchase a total number of item A or total amount of $B from retailer's stores over a period of T. Furthermore, as part of these rules, the retailer in some embodiments sets replacement or suggestion rules offering higher discount if a potential buyer substitutes an item and store-location with the retailer's suggestions.

2. Producer's Time-Location Sensitive Discount Items and Rules Database

The “Producer's Time-Location Sensitive Discount Items and Rules” database 105 includes all discounted items by producers as a function of location and time. The discount items and rules include single, wholesale, and group discount items and rules. Each registered producer updates this database in order to reflect new producer rules or to be more competitive in the auction. This database includes all discounted items by a producer as a function of location and time. A producer can offer different discounts at different geographical regions and with different expiration periods.

Furthermore, a producer in some embodiments defines and sets discount rules for wholesale and group discounts on specific items or total purchases by customers from that producer. For example, a producer in some embodiments sets rules to offer special discount if (a) a customer purchases a certain volume of item A over a period of T, (b) a customer purchases a total combined amount of $B from products offered by that producer over a period of T (week, month, year), and (c) a group of customers together purchase a total number of item A or total amount of $B from the producer's products over a period of T. Furthermore, as part of these rules the producer can set replacement or suggestion rules offering higher discounts if a user substitutes an item per producer's suggestions. For instance, a producer in some embodiments sets rules to suggest to a customer to replace a competitor's product with its own product in exchange for higher discounts, or suggest to a customer to replace an item with higher quality replacement (e.g., organic milk instead of regular milk) in exchange for higher discounts.

3. Shipper's Time-Location Sensitive Discount Items and Rules Database

Similar to the “Retailer's Time-Location Sensitive Discount Items and Rules” and “Producer's Time-Location Sensitive Discount Items and Rules databases, the “Shipper's Time-Location Sensitive Discount Items and Rules” database 115 includes all discounted items and rules by shippers as a function of location and time.

The discount items and rules include single, wholesale, and group discount items and rules. Each registered shipper updates this database in order to reflect new shipper rules or to be more competitive in the auction. This database includes all discounted services and items by a shipper as a function of location and time. A shipper can offer different discounts at different geographical regions and with different expiration periods.

Furthermore, a shipper in some embodiments defines and sets discount rules for wholesale and group discounts on specific items or total purchases by customers from that producer. For example, a shipper in some embodiments sets rules to offer special discount if (a) a customer purchases a certain volume of item A for shipment over a period of T, (b) a customer purchases a total combined amount of $B from services offered by that shipper over a period of T (week, month, year), and (c) a group of customers together purchase a total number of service or item A or total amount of $B from the shipper's services or products over a period of T. Furthermore, as part of these rules the shipper in some embodiments sets replacement or suggestion rules offering higher discounts if a user substitutes a service or an item per shipper's suggestions. For instance, a shipper in some embodiments sets rules to suggest to a customer to replace a competitor's service with its own service in exchange for higher discounts, or suggest to a customer to replace a service or an item with higher quality replacement (e.g., air shipment instead of ground shipment) in exchange for higher discounts.

4. Retailer/Producer/Shipper Database

The “Retailer/Producer/Shipper” database 120 includes information about all registered retailers, producers, and shippers. This includes unique database IDs for each, their login and authentication information, their locations and telephone numbers, etc.

5. Buyer Database

The “Buyer” Database” 125 includes information about all registered customers who are potential buyers. This includes unique database IDs for each buyer, their login and authentication information, and optional information such as shipping address, telephone numbers, etc.

6. Buyer's Location Database

The “Buyer's Location” database 130 includes the buyer location. The buyer can provide static locations for home/work, or the buyer can provide dynamic locations using positioning technologies (GPS, WiFi, etc.). The buyer's location is then used to provide location dependent offers, maps, and directions to stores.

7. Product Category Database

The “Product Category” database 135 includes categories for products. The categories are used to help users find their wanted products (e.g., Cameras, Dairy, etc.).

8. Product Database

The “Product” database” 140 includes actual products from a particular producer. Each category has one or more products inside it.

9. Wish-List Database

The “Wish-List” database 145 stores a list of items that potential buyers are interested in buying only if a wish-price level is met.

10. Shopping-List Database

The “Shopping-List” database 150 stores a list of necessary cart items (shopping list) that customers need to purchase within a time-frame and are looking for lowest price or best discount offered by combination of retailers/producers/shippers.

A. Application Modules

FIG. 1 shows several application modules (or engine programs) in some embodiments of the invention.

1. Discount Optimization Module

Engine E0 155 is a discount optimization module that handles single or group buyers and processes time and location dependent rules. This engine analyzes the data in the products, customers, retailers, producers, and shippers databases, calculates top discount values and scenarios, and presents them to a customer or group of customers (in group discount scenarios). This engine utilizes other functionalities and engines within the system to perform its tasks.

2. Discount Management and Delivery Module

Engine E1 157 is a discount management and delivery module that processes and delivers coupons/discounts to a customer or a group of customers. This engine handles different store types (physical, online), discount sources (retailer, producer, shipper), and discount types (coupon, e-Coupon, rebate, gift-card, cash-back, credit, direct cash, rewards).

3. Grouping Module

Engine E2 160 is a grouping module that helps form groups of customers in order to qualify for larger wholesale/group discounts. This grouping is either based on the system analyzing the purchasing profiles of customers and existing wish-lists/carts or is initiated at the request of customers. This engine is also to allow combinations of retailers/producers/shippers to form groups for “group sellers” discount, where for example two sellers can compete jointly for carts that include items from both sellers (as described in “Group-Sellers for Single/Group Buyers Online or Physical Store Wish-List or Shopping Cart” section below). This grouping is either initiated by the system or by sellers.

4. Social Networking Module

Engine E3 165 is a social networking module that helps with implementing a social networking capability between registered customers. This is implemented either on top of an existing social network (e.g., Facebook) or through a proprietary social network. The customers use this engine to share their carts, wish-lists, successful discount scenarios, and purchasing profiles with other customers. The customers utilize this network to identify and form groups to apply for higher group discounts. This engine is also used by sellers to form seller groups as discussed in the “Group-Sellers for Single/Group Buyers Online or Physical Store Wish-List or Shopping Cart” section below.

5. Suggestion Module

Engine E4 167 is a suggestion module that analyzes the customers' wish-lists/carts and suggests replacement items to customers. The suggestions in some embodiments are based on data/rules provided by retailers/producers/shipper in order to qualify the customers for higher single/group/wholesale discounts. Alternatively, the suggestions are based on other existing wish-lists/carts that already have a large number of customers signed up but may have slightly different items.

6. Discount Emulation Module

Engine E5 170 is an emulation module that customers use to emulate different wholesale/group discount scenarios and observe the potential discount as a function of group size or total purchasing amount.

7. Purchasing Profiling Module

Engine E6 175 is a purchasing profiling engine and data mines and analyzes the purchasing patterns of customers such as total spending levels, current wish-lists/carts, preferred product categories, preferred brands, location, etc. The results are then used by the other engines such as E0 155, E2 160, E3 165, E4 167, and E7 177.

8. Targeted and Customizable Advertisement Delivery Module

Engine E7 177 is a targeted and customizable advertisement delivery module, where the ads are based on customers' purchasing profiles/trends/locations and customers' current wish-list/carts.

9. Mapping Module

Engine E8 180 is a mapping module that uses a map database, the buyer's location (from the buyer's location database), and store locations to calculate distances and provide maps, directions and store suggestions for in-store purchases.

10. Differentiator Module

Engine E9 185 is a differentiator module that helps the system differentiate the items entered by customers as a wish item or a necessary shopping item. For wish items (referred to as wish-list), the customers intend to purchase them only if a wish-price level is met. For necessary items (referred to as shopping cart/list), the customers need to purchase them within a time-frame and are looking for lowest price or best discount offered by combination of retailers/producers/shippers. Therefore, the discount optimization engine of E0 155 uses a different procedure and discount rules for these two categories. Engine E9 185 helps with categorizing and differentiating these two categories.

11. Authentication Module

Engine E10 187 is an authentication module that uses information in the “Buyer's Database” to authenticate a buyer and allow them to use the system. The authentication engine also uses the “Retailer/Producer/Shipper's” Database 120 to authenticate retailers, producers, and shippers.

### II. Usage Scenarios

Several more embodiments are described in the following sections by describing different usage scenarios. Although different scenarios are described by referring to wish lists and shopping lists (or shopping carts), as discussed above, all processes, scenarios, and methods disclosed by referencing to wish lists are equally applicable to shopping lists (or shopping carts) and vice versa.

A. Online Group-Buyer Wish-List Shopping

This usage scenario describes embodiments where a customer intends to purchase a few items through an online store. The customer has a price limit/range where he/she is only willing to purchase the items if those price limits are met by a retailer or producer. Therefore, customer's list is referred to as wish-list since the customer is wishing to purchase those items only under some price conditions. Some embodiments process all customers' wish items combined with the discount rules by a group of registered retailers/producers to maximize the available discount to customers with a common wish-item. This is primarily achieved by qualifying for higher group and/or wholesale discounts by increasing the size of the group of customers with a common wish-item. The embodiments are described below using an exemplary scenario. The wholesale discounts are applicable both when the size of the group of customers with a common wish-item is increased as well as when individual customers agree to buy larger quantities at once or over a period of time.

The customer enters different items (e.g., items A, B, and C) as items he/she wishes to purchase over a time period, T. For web purchases, every item is processed separately and independently. When entering an item A (such as item A), the following actions take place in some embodiments. Using the data available online and data in the customer's database and the active wish-list database, the system calculates a price range for item A based on existing data online and/or based on price range selection by other customers who have entered item A in their wish-lists. Then a reasonable price range for item A is calculated and suggested to the customer and he/she enters a wish price for item A. Then, engine E4 167 analyzes the item A in terms of group/wholesale discount potential. Engine E4 167 may conclude that item A is not highly likely to qualify for large group discount since either number of customers signed up for item A is relatively low or the available producers/retailers carrying item A do not offer attractive group discount for item A. Engine E4 167 then analyzes item A against similar items (either in the same category by a different manufacturer or in a different category by the same manufacturer). Engine E4 167 may conclude that a similar item A′ is more likely to qualify for higher group discount (e.g., since a large number of customers have item A′ in their list). Engine E4 167 then suggests replacement item A′ to the customer. The customer then decides to accept or reject the suggestion and proceed with original item A or replacement item A′. In some embodiments, the replacement suggestion is made in order to satisfy a maximum price that the customer has set of item A.

Once a customer confirms either item A or A′, he/she can share that item with friends through a mailing list or social network enabled by engine E3 165. Next, the “Discount Processor” completes the auction and selects the winning retailer/producer that offers the highest discount to a group of customers by meeting the wish-prices of a large number of customers. At a given time during the process, a customer can utilize engine E5 170 to emulate the potential discount (or final price) for an item in his/her wish-list as a function of number of customers that may sign up for that item.

B. Single-Buyer Online or Physical Store Shopping Cart (Necessary Items)

This usage scenario describes an example of the embodiments where a customer creates a list of necessary items that he/she will be purchasing within a time-frame (week, month, etc.). The customer would not normally set a price range for these items since he/she is looking for the best discount/price and doesn't necessarily have a trigger price for those items as they are necessary items. An example would be a list of grocery items where the customer is planning to purchase those grocery items within a day or week and is interested in the best total price from different retailers or producers. In this example, wholesale/group discount feature is not included or described for ease of explanation. This example is applicable to both physical and online stores. Although the description below is given for a physical store pickup, a person of ordinary skill in the art would realize that the description can be applied to online stores.

Customer enters items A, B, C. The “Discount Processor” compares these items against the latest discount lists/rules provided by retailers R1 (e.g., Ralphs chain) and R2 (e.g., Albertson chain) and maintained in their respective databases within the system. Let's say item A qualifies for discount by retailer R1 if the customer purchases it from R1-S1 (e.g., store S1 by retailer R1) within time R1-T1. This is enabled by the time-location sensitive aspect of discount/rule databases updated by retailers. Similarly, item B can qualify for a discount by retailer R2 if the customer purchases it from store R2-S1 by time R2-T1. The system uses customer's current and past locations history to only consider store locations that are within a vicinity range.

The Discount Processor then calculates and presents the above discounts to customer indicating the discount amount offered by R1 and R2 options indicating customer can get a discount on item A from R1 and a discount on item B from R2. The customer may (but not necessarily) decide to purchase all items from only one store (R1-S1 or R2-S1) where the total saving is maximized. Now for item C, following scenario can happen. Based on discount/rule database provided by R1, engine E4 167 concludes that item C does not qualify for any discount as is by retailer R1. Using different replacement/suggestion algorithms, the suggestion engine E4 realizes a similar item C′ qualifies for discount by R1 (where C′ can be a slightly different item than item C or a similar item from a different producer). In this case, the system suggests the replacement item C′ to customer and the potential discount offered by retailer R1. The user then decides to accept or reject the suggested replacement. Based on customer's decision, the final list and final discount is adjusted and confirmed. At any time, a customer can share his/her list of items (current, past, along with discounts) with friends through social networking engine E3 165.

Depending on the type of discount (rewards, direct discount, cash-back, gift card), engine E1 157 is utilized to process or deliver the method of discount. For the case of a physical store or grocery store, engine E1 157 utilizes a method of discount delivery as described below. Assume the user has already entered to the system his/her club/membership serial number with retailers R1 and R2. By accepting the total discount offered by R1, the discounted items and discount values are linked to customer's club/membership number with retailer R1. This data is then transmitted to retailer R1. When the customer visits store R1-S1 to purchase items A, B, C, and enters his/her club/membership number, the offered discounts are applied accordingly at the cashier checkout.

C. Group-Buyers Online or Physical Store Shopping Cart (Necessary Items)

This usage scenario describes an example of the embodiments where a group of customers are grouped together to qualify for higher wholesale/group discount based on their “purchasing history and profile”. This case applies to necessary purchases by a group of customers (unlike the “Online Group-Buyer Wish-List Shopping” scenario described above which described wish-list shopping by a group of customers). The system utilizes customers' purchasing profiles (by engine E6 175) to create groups of customers (by engine E2 160) to qualify for higher group discounts by the discount processor. Individual customers can utilize the system to invite friends to join a group for higher discount (through engine E3 165). Below is given an example.

Assume customers C1 to C100 are regularly purchasing grocery items from R1 or R2 and are using the system for receiving discounts. Engine E6 175 analyzes the purchasing histories and profile of members' database and identifies C1 to C100 as having a “common purchasing profile”. A “common purchasing profile” could be due to one of the following: i) they regularly purchase a common item, ii) they make regular purchases from a retailer R1, iii) they spend a similar amount on purchases from retailer R1 or producer P1, iv) they purchase a similar volume of a common item from a retailer R1 or producer P1. Then engine E6 175 forms a group by these customers (C1 to C100) tagged with their common purchasing profile.

The Discount Processor then uses the above common group purchasing profile to identify group/wholesale discounts by retailers R1 and R2 based on their group discount items/rules. As one example, if C1-C100 all purchase item A regularly, the Discount Processor analyzes the discount rules by retailer R1 to see if R1 offers additional discount when 100 instances of item A are purchases together (within a location/time constraint). As another example, if C1-C100 each make an average monthly grocery purchase of $B, then the Discount Processor analyzes the discount rules by retailer R1 to see if R1 offers additional group/wholesale discount if a total purchase of “100×$B” (100 times higher purchasing power) is done through R1. The above group/wholesale discounts are calculated for retailer R2 as well. The system then presents the above potential group discount description/scenario and value to C1-C100. The group discount is delivered or applied only if say 80% of customers C1-C100 accept and commit to the group discount. For instance, 80% of them agree to spend $B on purchases from R1 over the next month (e.g., through a gift card). The group of C1-C100 can review and either accept or decline the group discount. If 80% of those customers agree and commit, the group discount offer by R1 is exercised and applied.

Formation of C1-C100 group can be done in two ways. In one case, engine E6 can do the analysis and identify a common purchasing profile and initiate a group discount calculation by the Discount processor. In another case, customers can create and expand a group by inviting friends through engines E2 and E3. Once the members within the groups grow beyond say 100, the engine can then analyze and process potential group discounts for the group as described above.

D. Combined Producer/Retailer Discount for Single/Group Buyer(s) Online or Physical Store Cart Shopping

This usage scenario describes an example of the embodiments where a single customer or a group of customers receive discounts from both a retailer (e.g., R1: Ralphs Chain) and a producer (e.g., P1: Milk Brand) for purchasing an item in their wish-list or cart. Below is given an example for a single customer case. The example can be generalized to group/wholesale discount case.

Assume a customer enters items A, B, C. The “Discount Processor” compares these items against the latest discount lists/rules provided by retailers R1 (e.g., Ralphs chain) and R2 (e.g., Albertson chain) and producers P1 (e.g., Milk Producer 1) and P2 (e.g., Milk Producer 2). This data is stored and maintained in their respective databases within the system. Let's say item A qualifies for discount by retailer R1 if the customer purchases it from R1-S1 (e.g., store S1 by retailer R1) within time R1-T1. This is enabled by the time-location sensitive aspect of discount/rule databases updated by retailers.

Similarly, item A can qualify for a different discount by retailer R2 if the customer purchases it from store R2-S1 by time R2-T1. If item A is a specific brand produced by producer P1, then the “Discount Processor” analyzes item A for possible discounts by producer P1 as well. The combined discount by {R1 and P1} and {R2 and P1} for item A is calculated and compared if item A is a product produced by P1. Then, engine E4 167 analyzes item A to see if a similar item is offered by another producer P2 with possible higher discount. If an item A′ is identified to be produced by P2, the replacement is suggested to customer. If customer accepts the suggested item A′, the “Discount Processor” then calculates potential discounts by following combinations: {Item A by R1 and P1}, {Item A by R2 and P1}, {Item A′ by R1 and P2}, and {Item A′ by R2 and P2}. The “Discount processor” then finds the best value (or highest discount) and presents the top choices to customer. Upon customer's selection, engine E1 157 performs the task of discount delivery by the winning retailer and producer combination (in the form of direct discount, cash-back, rebate, etc.).

E. Group-Sellers for Single/Group Buyers Online or Physical Store Wish-List or Shopping Cart

This usage scenario describes an example of the embodiments where a group of retailers/producers group together to offer higher total discount on a “combination of items” in a buyer's wish-list or cart items. These additional discounts/rewards by grouping of retailers/producers can be applied to single-buyer case or group-buyer case. Furthermore, it can be applied to wish-list case or cart list case. For example, a group of producers join together to offer a total discount on a buyer's cart where a subset of items in the buyer's cart are offered/provided by one producer where another subset of items are offered/provided by the other producer. Below is given an example for single-buyer case with no loss of generality (it can be generalized to group-buyer case).

Assume a buyer has entered items A and B in his/her wish list or cart list. Item A is an item offered by producers P1-A and P2-A (limited to two for ease of description) and item B is an item offered by producers P1-B and P2-B (limited to two for ease of description). In single-producer mode, normally producers P1-A and P2-A would compete for item A in buyer's list while producers P1-B and P2-B compete for item B in buyer's list. Depending on the level of offered discount, the buyer may finally purchase item A only, item B only, both items, or neither one. In group-producer mode, the system enables the buyers to form groups together and offer a combined discount on combination of items A and B in buyer's list. For example, possible buyers groups of {P1-A, P1-B}, {P1-A, P2-B}, {P2-A, P1-B}, {P2-A, P2-B} can be formed and compete for the total of buyer's list (offering both items A and B).

In general, the grouping of buyers can be initiated either by the buyers directly or suggested by the system. In first case, producers can identify suitable/potential grouping partners and enter grouping information and preferences along with “group sellers” discount rules. In second case, the system identifies potential valuable sellers groupings based on buyers' wish-lists and carts profiles. Then the system suggests to those matching producers to accept and form producers group and enter “group producers” discount rules.

In addition to features described above, the application modules/engines FIG. 1 perform the following operations to support the mode of operation for this usage scenario.

Discount Optimization Engine, E0 155 processes “sellers group” discount scenarios and rules. When a buyer enters items A and B in his/her wish-list or cart, this engine also analyzes discounts offered by available groups of sellers that can jointly supply both items in buyer's list.

Grouping Engine, E2 160 allows combinations of retailers/producers/shippers to form groups for “group sellers” discount. For example, a seller can invite another seller to form a group and compete jointly for carts that includes items from both sellers. In another mode, the engine analyzes the purchase profiles of buyers' and searches for potential groups of sellers that can form groups to compete better for more buyers' lists. These potential suitable groups are then suggested to those sellers.

Social Networking Engine, E3 165 allows for sellers to perform social networking activities as well. This is in particular helpful when sellers are local small business owners and use the networking feature to search for other local sellers to form sellers groups to better compete for buyers' carts.

Suggestion Engine, E4 167 conducts replacement analysis for items in buyers' cart taking into account any additional discounts by available group sellers. For example, if a customer has entered items A and B in his/her cart, E4 would run a replacement analysis and may conclude that a combination of items A and B′ qualifies for more discount by a group of sellers (one offering item A and the other offering item B′). In this case, item B′ is suggested to that buyer to replace original item B.

Discount Emulation Engine, E5 170 emulates discount scenarios based on any available sellers grouping discounts/rules.

Purchasing Profiling Engine, E6 175 is utilized to identify patterns in buyers' lists in terms of possible qualifications for “group sellers” discount. Any identified pattern is used to suggest grouping options to sellers.

In addition to information described above, the databases of FIG. 1 include the following information items to support the mode of operation for this usage scenario. In terms of databases of retailers/producers/shippers, information elements are added to store/track groupings data between different vendors. “Sellers group” discount combinations and rules are updated (e.g., in databases 105-115) and confirmed by sellers participating in a “sellers group” discount offering.

As an example, retailer R1 enters an additional rule (in database 105) for item A where an additional discount amount is offered for item A in a buyer's list if item A is purchased in combination with item B from retailer R2. Retailer R2 would need to confirm this grouping and may enter a rule to offer additional discount as well if item B is purchased in combination with item A from retailer R1. In general, sellers can participate in many different groups based on their product profiles, locations, compatibility, etc.

### III. Interactions of a Brick and Mortar Retail Seller with the Discount Processing Auction Site

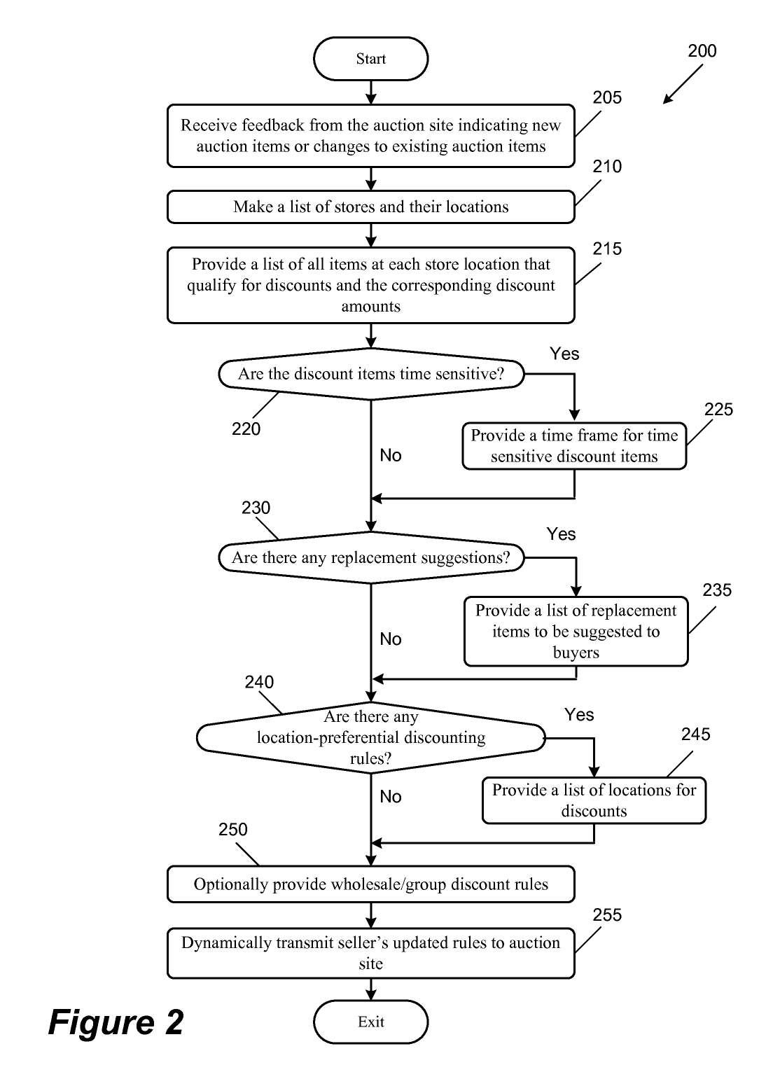

FIG. 2 conceptually illustrates a process 200 for the interaction of a brick and mortar retail seller with the discount processing auction site in some embodiments of the invention. As shown, the process receives (at 205) an indication from the auction site regarding new auction items or changes to auction items on the auction site. This indication in some embodiments in the form of a notification that is either web-based or application-based. The discount rules are in any previously agreed upon format such as XML. In some embodiments, a seller gets notification whenever there is a change in data that can impact the items offered by that seller. For instance, if number of potential buyer listing an item in their wish list changes, the seller can configure to get a notification to be informed to make adjustments to rules if desired.

Next, the process makes (at 210) a list of stores of the seller and their locations. The process then provides (at 215) a list of all items at each store location that qualify for discounts and notes the discount amount. These discounting rules in some embodiments do not take into account pooling of buyers. The discount amounts can vary from one store to the next. If the discount amounts vary with time, the process provides a time frame for each discount. As shown, the process determines (at 220) whether the discount times are time sensitive. If not, the process proceeds to 230 which is described below. Otherwise, the process provides (at 225) a time frame for each time sensitive discount item. For instance, a certain item can be discounted for 20% for a week and then go to 10% discount thereafter.

The process optionally provides a list of replacement items to be suggested to a buyer if the seller does not have certain items or in order to increase the discount amount to the buyer. As shown, the process determines (at 230) whether there are any replacement suggestions for a higher discount. If not, the process proceeds to 240 which is described below. Otherwise, the process provides (at 235) a list of replacement items to be suggested to buyers for each item. For example, the seller can recommend store brands or generic brands over more expensive brands, or suggest organic milk over regular milk.

The process also optionally provides location-dependent rules. As shown, the process determines (at 240) whether there are location-preferential discounting rule. If not, the process proceeds to 250 which is described below. Otherwise, the process provides (at 245) a list of locations for different discounts. For instance, a retailer can have four stores, A, B, C and D that are close to each other. But if store A has more perishable grocery inventory than the others then store A location gives more discounts on those perishable items.

Next, the process optionally provides (at 250) wholesale/group discount rules. The store may also provide different classes of rules such as group discount rules, discounts per number of items in a group (e.g., 10% discount on 1000 or more one gallon milks), or discounts on the total purchase price (e.g., 20% discount on purchase of $10,000 dollars or more). For example the rule can indicate the followings:

If 100<No. of Buyers<=1000 then discount=5%

If 1001<No. of Buyers<=10000 then discount=10%

If 10001<No of Buyers then discount=15%

or:

If $100<Total Purchase Amount<$1000 then discount=10%

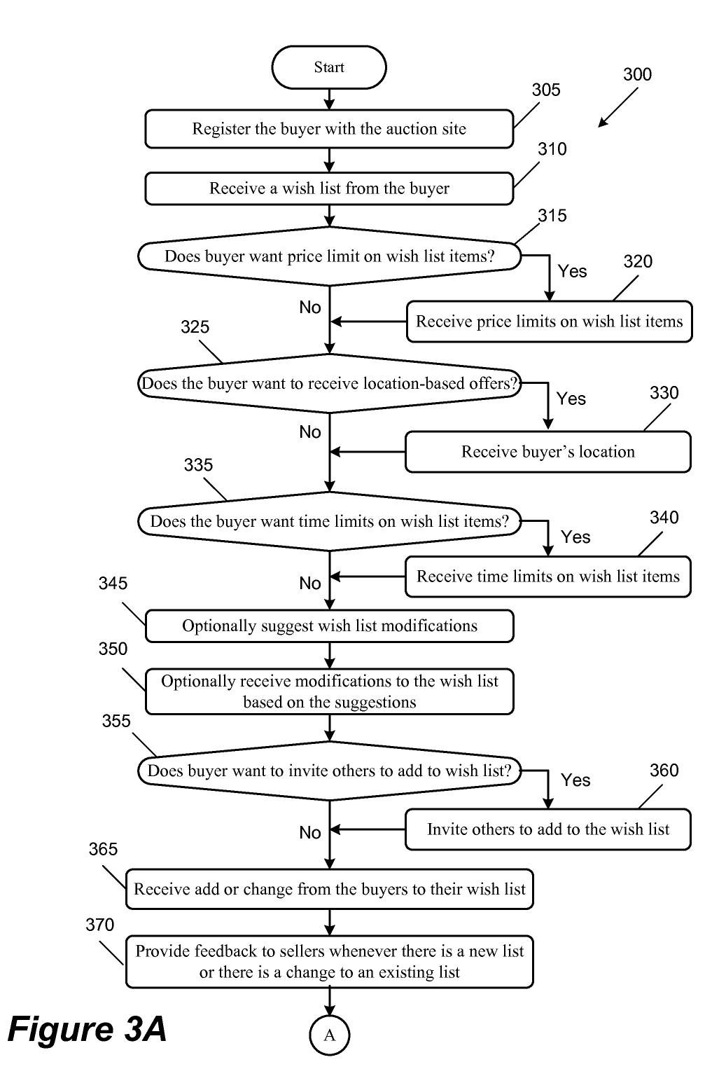

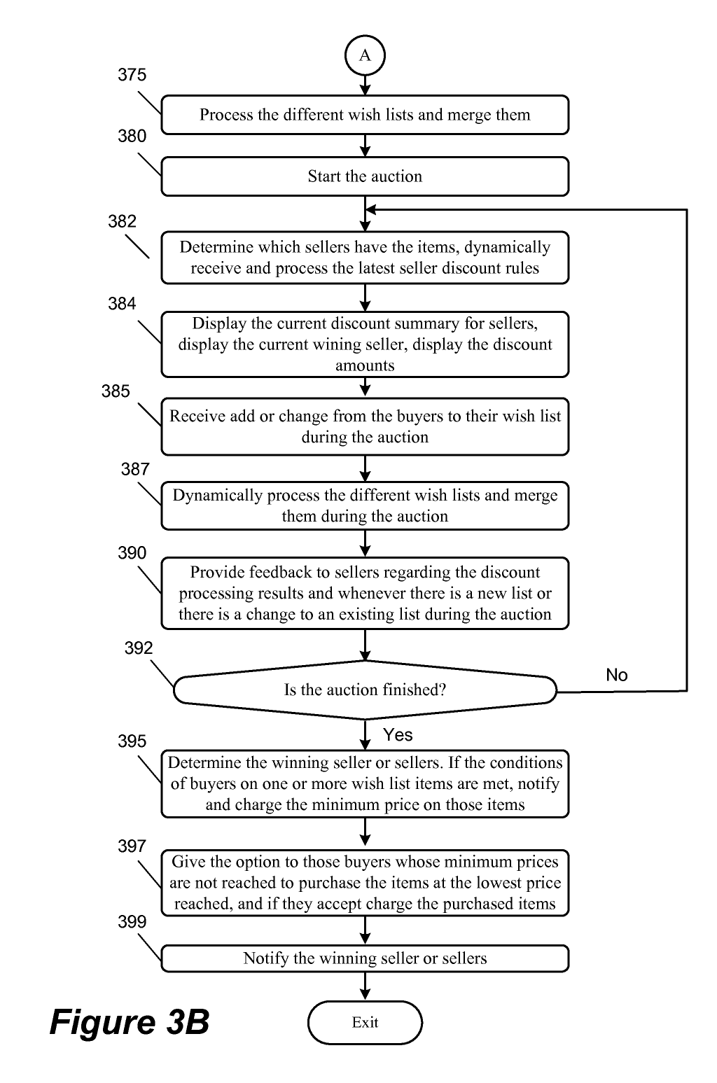

When the process has formulated all of the seller's discount rules, the process transmits (at 255) the rules to the discount processing auction site. The process then exits. As the seller receives additional feedback from the auction site about new buyer item requests or the latest auction results (e.g., another seller is winning the auction) the seller may modify its rules and the process transmits them to the auction site in order to win the auction (Seller modifications to its rules is further described by reference to FIG. 3, below).

One of ordinary skill in the art will recognize that process 200 shown in FIG. 2 is a conceptual representation of the operations used for the interaction of a brick and mortar retail seller with the discount processing auction site. The specific operations of process 200 may not be performed in the exact order shown and described. Furthermore, the specific operations of process 200 may not be performed in one continuous series of operations and different specific operations may be performed in different embodiments. Also, the process could be implemented using several sub-processes, or as part of a larger macro process.

### IV. Interactions of an Auction Site with a Buyer

FIG. 3 conceptually illustrates a process 300 performed at an auction site for the interaction of a buyer with the discount processing of auction site in some embodiments of the invention. This process resembles the interaction for “Usage Scenario for Online Group Wish-List Shopping”, described above. However, as discussed above, all processes in this specification are equally applicable to wish lists and shopping lists (or shopping carts). As shown, the process registers (at 305) the buyer with the auction site (e.g., when the buyer goes to the web site or application and registers if he/she has not registered before). Next, the process receives (at 310) a wish list (or shopping list) from the user (e.g., when the buyer uses the web site or an application of the auction site to create the buyer's wish list (or shopping list) of items).

The auction site in some embodiments has user friendly features such a web form to fill out and describe the items, a search function to find items, or subcategories (e.g., Electronics->Cameras->Digital->Canon->Model). Other means for the user to form a wish list (or shopping list) in some embodiments is providing the auction site with product identifiers such as Universal Product Code (UPC), Stock Keeping Unit (SKU), and International Standard Book Number (ISBN). For example, the user enters these manually or uses a scanner to send these to the auction site.

The process then determines (at 315) whether the buyer wants to set price limits on the wish list items. If not, (e.g., when the list is a “must buy” list and the buyers just wants to get the best price for the items) the process proceeds to 325 which is described below. Otherwise, the process receives (at 320) the price limits for the wish list items from the buyer. The buyer can set maximum price limits or minimum discount percentages from the list price for each item on the list before he/she would commit to buying the item. Alternatively, the buyer may not specify a minimum price or discount in which case at the end of the auction the system has to get authorization from the buyer as to whether the buyer wants to buy the item at the lowest found price. The list price can be the manufacturer's suggested retail price (MSRP) or the lowest price found on the Internet.

The process then determines (at 325) whether the buyer wants to receive location-based offers. If not, the process proceeds to 335 which is described below. Otherwise, the process receives (at 330) the buyer's location. The buyer in some embodiments optionally turns a location feature on, where the buyer provides the auction site with the buyer's location in order for the auction site to provide location-dependent offers. The buyer in some embodiments provides static locations for home, work, etc. at different resolutions (state, county, city, zip code, and street address, where the coarser addresses provide more privacy). Alternatively, the buyer provides dynamic locations by using positioning technologies (GPS, WiFi, etc.). The auction site then utilizes that information to suggest physical store locations that are close to the buyer.

The process then determines (at 335) whether to buyer wants time limit on the wish list (or shopping list) items. If not, the process proceeds to 345 which is described below. Otherwise, the process receives (at 340) time limit on wish list (or shopping list) items from the buyer. For instance, the buyer sets time limits on the wish list (or shopping list) items such as: “I want item A today” and “I want item B within one month”.

In some embodiments, the auction site has a suggestion engine. In these embodiments, process 300 analyzes the buyer's wish list (or shopping list) and compares it with other existing wish lists (or shopping lists), and previous transaction histories of its users and makes (at 345) suggestions to the buyer in terms of making the wish list (or shopping list) more attractive to sellers (producers, retailers, shipping companies) and other buyers. Possible suggestions include changing brand or changing product category. For example, the system can suggest to the buyer to not specify a particular brand of milk since there are a large group of other buyers who have specified a particular brand. The process then optionally receives (at 350) from the buyer modifications to the wish list (or shopping list) based on the auction site suggestions.

The process then determines (at 355) whether the buyer wants to invite others to add to the wish list (or shopping list). If not, the process proceeds to 365 which is described below. Otherwise, the process receives information about the others and invites (at 360) them on behalf of the buyer to add to the wish list (or shopping list). For instance, the buyer in some embodiments uses social networking sites to invite friends and family to join that list and add to it in order to qualify for a bigger discount. Other registered buyers/visitors to the web site can also see the newly created buyer's wish list (or shopping list) and pool their purchasing power to increase savings. The process in some embodiments also provides a ‘private wish list’ (or ‘private shopping list’) option to a buyer or a corporation in order to limit the invitation and the auction to a controlled group. In a general situation, however, the buyer is interested in maximizing his/her bargaining power and is likely to use both public buyers as well as personal contacts. The other buyers can either add the items to their own wish list (or shopping lists) or, if a particular buyer allows, to the same wish list (or shopping list) as the particular buyer. For instance, the other buyers can add their items to the particular buyer's list (when the particular buyer has granted such permission) and tag the added items with their own account number. In case of the same family members or the same company employees who use the same account number, the other buyers can add their items to the same wish list (or shopping list) where each buyer tags their items with their own name or identification.

Once the first buyer's wish list (or shopping list) is submitted and posted on the auction site it is available for others auction site users to see (unless it is a private list). The process then receives (at 365) adds or changes (if any) to the wish list (or shopping list) by the buyers at the auction site. For instance, other buyers add their wish list (or shopping list) items or join in some of the first buyer's items.

The process provides (at 370) feedback to the sellers whenever there is a new wish list (or shopping list) or there is a change to an existing list (as was discussed by reference to operation 205 in FIG. 2) so that they can update their rules appropriately. The process automatically processes (at 375) the different wish lists (or shopping lists) and merges the items together. In some embodiments, merging the items includes calculating the total quantity or value of an item that is included in the lists of several buyers and using the total quantity or value of the item to calculate the applicable discounts for all buyers.

The process then starts (at 380) the auction. The auction gets started either by buyers or by the auction site. If the auction gets started by buyers, the process starts the auction after an indication is received from one or more buyers to start the auction.

Once an auction is started the process determines (at 382) which sellers have the items and processes the discount rules of the sellers. The process displays (at 384) the current winning seller and displays the discount amount to the buyers. For instance, the buyer is shown (or is otherwise informed by audio, text message, etc.) the list of discounts offered by sellers (or just the top few sellers) and the final winning seller. If the buyer decides or agrees to modify his/her wish list (or shopping list), then new top discounts by sellers are displayed to the buyer. Also in the background, depending on a particular configuration, all or sections of information presented to the buyer are shared or displayed to participating sellers.

The process then dynamically receives (at 385) add or change from the buyers to their wish lists (or shopping lists) during the auction. The process dynamically processes (at 387) the different wish lists (or shopping lists) and merges them during the auction. In some embodiments, merging the items includes calculating the total quantity or value of an item that is included in the lists of several buyers and using the total quantity or value of the item to calculate the applicable discounts for all buyers. The process also notifies (at 390) the sellers about the discount rules processing results so that the sellers can modify their rules and improve their chances of winning the auction (as was described by reference to FIG. 2, above). The process in some embodiments notifies the sellers about the results of all the bidding (e.g., 1^{st} place seller wining the auction currently is X, 2nd is Y, . . . and you are in 5^{th} place, etc.). In other embodiments, the process notifies the sellers with more limited information such as their position in the auction (e.g., you are in 5^{th} place). The process also notifies (at 390) the sellers of the changes to the buyers' wish lists (or shopping lists).

The process then determines (at 392) whether the auction is finished. If yes, the process proceeds to 395 which is described below. Otherwise, the process proceeds to 382 to continue the auction. The interaction between buyers and the auction site, buyers and other buyers, and sellers and the auction site continues until the auction is finished. The auction is finished in different embodiments with different conditions such as a certain time has passed, a certain discount/price has been reached, voting of the buyers on the list, or manually by the auction site moderator.

Once the auction is finished, the process determines (at 395) the winning seller (or sellers). If a particular buyer's constraints for purchasing one or more items on the wish list (or shopping list) are met then the buyer is notified and is charged for that item with the buyer's preferred payment method (credit card, reward points, etc.). The process gives (at 397) the option to those buyers whose minimum prices are not reached to purchase the items at the lowest prices reached at the auction, and if they accept they are also charged. The process then notifies (399) the winning seller or sellers. The process then ends.

One of ordinary skill in the art will recognize that process 300 shown in FIG. 3 is a conceptual representation of the operations performed at an auction site for the interaction of a buyer with the discount processing of auction site. The specific operations of process 300 may not be performed in the exact order shown and described. Furthermore, the specific operations of process 300 may not be performed in one continuous series of operations and different specific operations may be performed in different embodiments. Also, the process could be implemented using several sub-processes, or as part of a larger macro process.

### V. Example Databases and Usage Scenarios

This section provides examples of database structures that are maintained in some embodiments of the invention. Examples of database structures that are maintained by some embodiments for retailers, producers, and buyers are given below. For retailers/producers, database structures to manage discounted items and discount rules are presented.

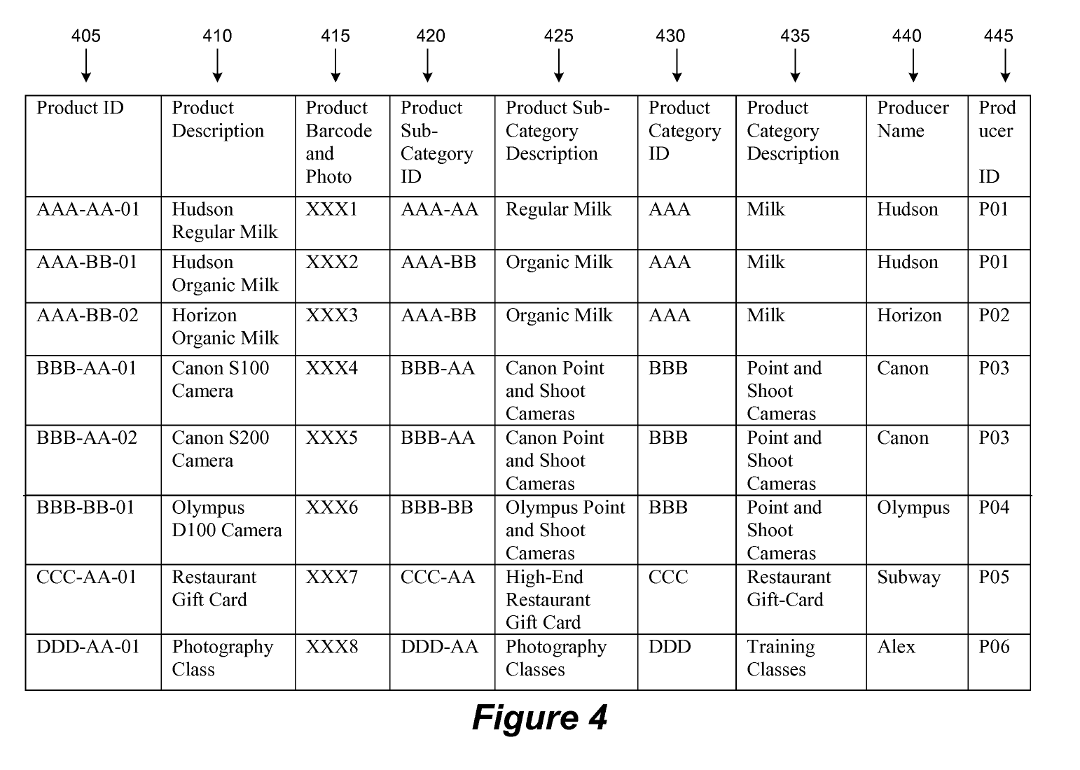

FIG. 4 conceptually illustrates examples of the information elements associated with a product that are stored in different databases in some embodiments of the invention. In some embodiments, when a producer/retailer/buyer enters a product, these information elements are provided as well (when possible). Each product is assigned unique product identification (Product ID) 405. A product description 410 and product barcode and/or photos 415 are attached when available. Each product in some embodiments is associated with multiple category layers (from more specific to more generic categories). For example here, a “sub-category” (more specific) and a “category” (more generic) are assigned to each product. Each sub-category includes a description 425 and is assigned with unique identification number 420 for ease of database management. Similarly, each product category includes a description 435 and a unique identification number 430. Finally, each product is assigned a producer name 440 and unique producer identification number 445. FIG. 4 shows several product samples and their corresponding information elements.

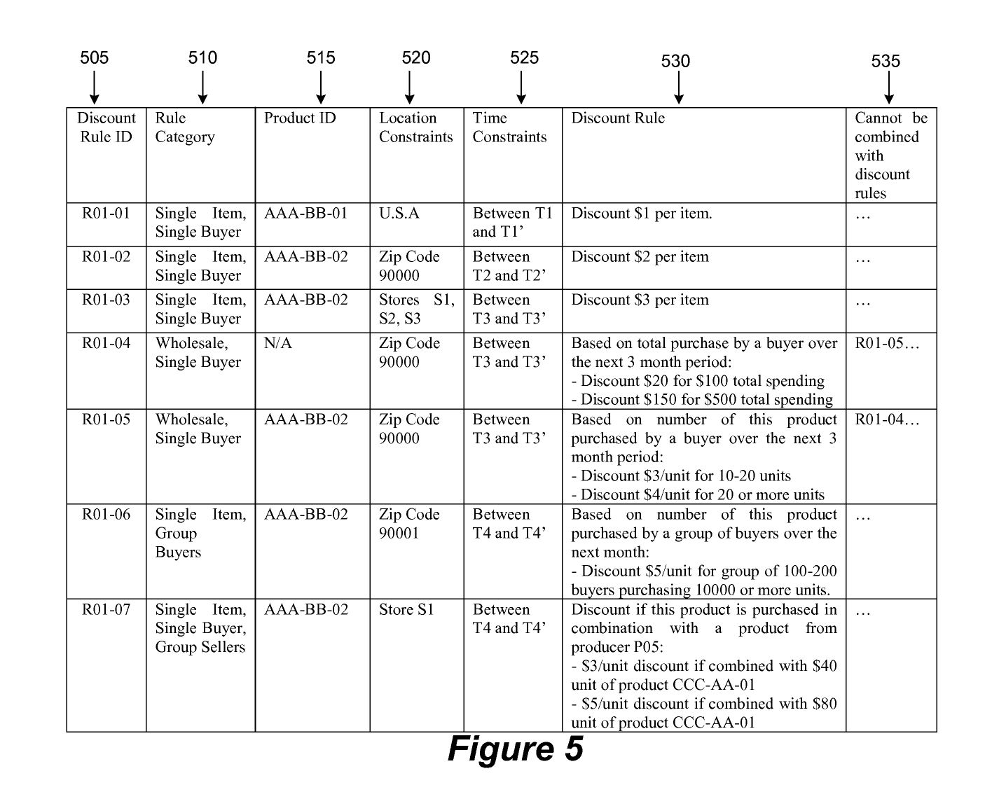

FIG. 5 conceptually illustrates a sample “producer database” storing discount items and rules for a producer in some embodiments of the invention. A producer in some embodiments can modify an existing discount rule or add a new discount rule. This database includes several discount rules. The discount processor engine uses all these discount rules to identify suitable discounts applicable to a potential buyer. The example of FIG. 5 shows the discount database filled out by producer “Horizon” (producer ID P02).

Each discount rule is assigned a unique identification (ID) 505 for ease of processing and database management. As shown, each discount rule is assigned a “rule category” 510. The second demonstrates different options for this element such as “single item, single buyer”, “wholesale, single buyer”, “single items, group buyers”, “single item, single buyer, replacement incentive”, etc., as described in previous sections. “Product ID” 515 lists the product that a discount rule is applicable to. “Location Constraints” 520 is the geographic region where this discount rule is applicable. It can be limited to a zip code, city, state, etc. Similarly, “Time Constraints” 525 contains any time limitations applicable to this discount rule (e.g., “end of day”, “between two certain dates/times”).

“Discount Rule” 530 describes the discount scenario. This can be a simple discount scenario (e.g., discount amount per product item), wholesale discount scenario (where a buyer commits to buy a total wholesale amount over a period of time), group buyers discount scenario (where a group of buyers commit to buy a total amount of product over a period of time), group sellers discount scenario (where a group of sellers jointly discount multiple items in a buyer's list). Different examples are given in FIG. 5. Last columns 535 given the option to producer to specify which discount rules can be combined and which discount rules cannot be combined.

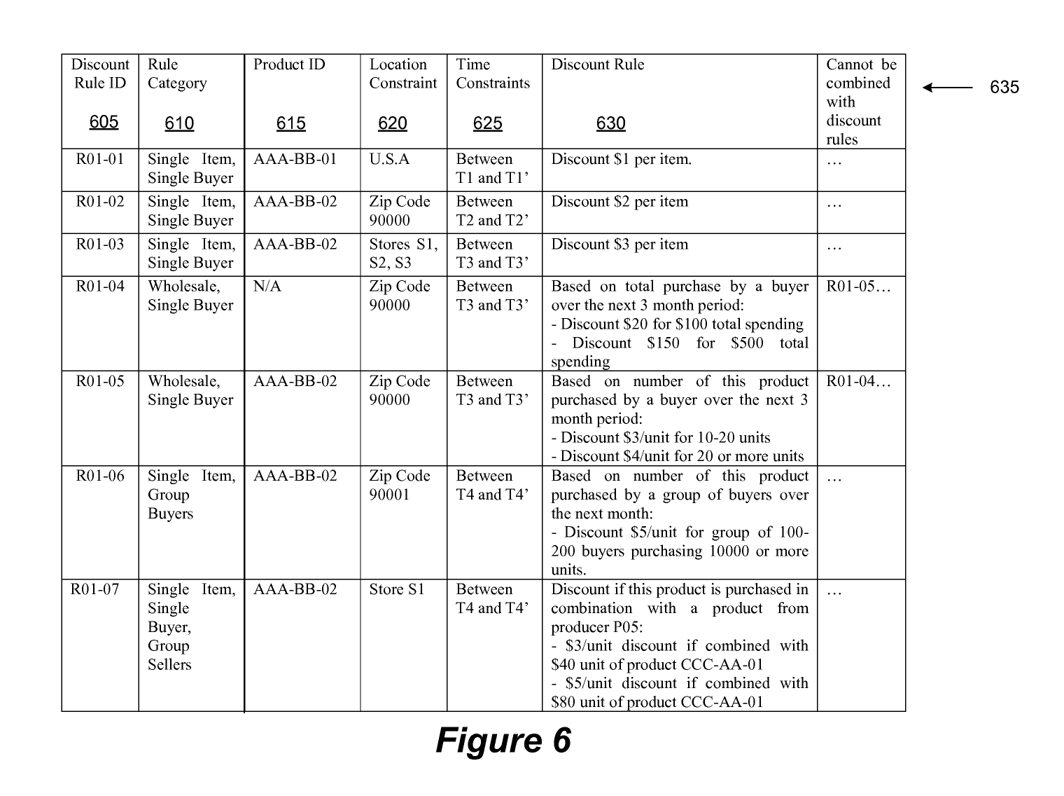

FIG. 6 conceptually illustrates a sample “retailer database” storing discount items and rules for a retailer in some embodiments of the invention. In this example, the discount database filled out by retailer “Ralphs” (retailer ID R01). Similar to that of the producer database of FIG. 5, the retailer database of FIG. 6 includes the following information. Each discount rule is assigned a unique ID 605 for ease of processing and database management. As shown, each discount rule is assigned a “rule category” 610. Second column demonstrates different options for this element such as “single item, single buyer”, “wholesale, single buyer”, “single items, group buyers”, etc. as described in previous sections.

“Product ID” 615 lists the product that a discount rule is applicable to. “Location Constraints” 620 is the geographic region where this discount rule is applicable. It can be limited to a zip code, city, state, etc. Similarly, “Time Constraints” 625 contains any time limitations applicable to this discount rule (e.g., “end of day”, “between two certain dates/times”). “Discount Rule” 630 describes the discount scenario. This can be a simple discount scenario (e.g., discount amount per product item), wholesale discount scenario (where a buyer commits to buy a total wholesale amount over a period of time), group buyers discount scenario (where a group of buyers commit to buy a total amount of product over a period of time), group sellers discount scenario (where a group of sellers jointly discount multiple items in a buyer's list). Different examples are given in FIG. 6. Last column 635 gives the option to retailer to specify which discount rules can be combined and which discount rules cannot be combined.

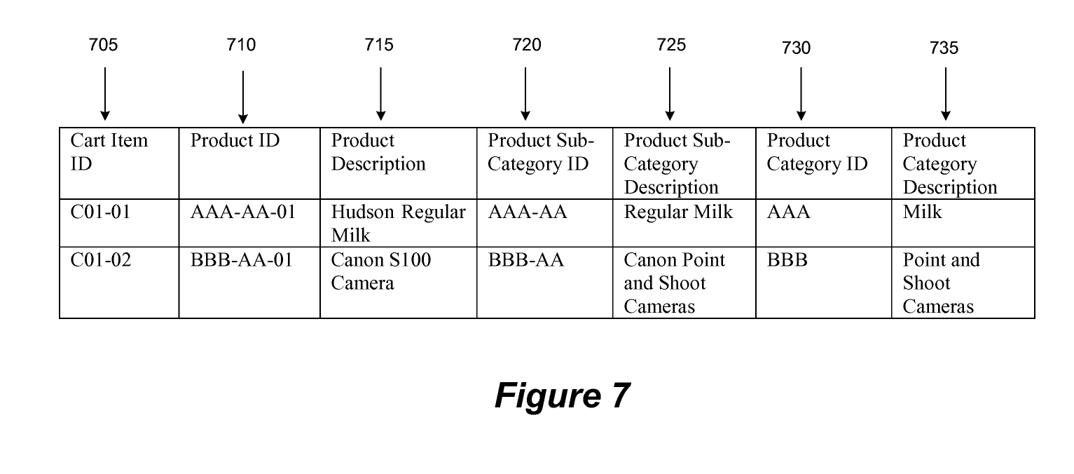

FIG. 7 conceptually illustrates example of the information that a buyer enters into a shopping cart in some embodiments of the invention. In this example, the buyer with ID number C01 enters two items to his/her shopping cart. These are items that the buyer has decided to purchase and is only looking for the best available discounts. As the buyer enters these items the “discount processing” engine analyzes them against all available discount rules by retailers/producers and presents discount scenarios and/or replacement suggestions to the buyer. Each item includes a cart ID number 705, a product ID 710, product description 715, product sub-category ID 720, product sub-category description 725, product category ID 730, and product category description 735. The example of FIG. 7 relates to the shopping cart case as described in the usage scenarios for “Single-Buyer Online or Physical Store Shopping Cart (Necessary Items)” and “Group-Buyers Online or Physical Store Shopping Cart (Necessary Items)”, above.

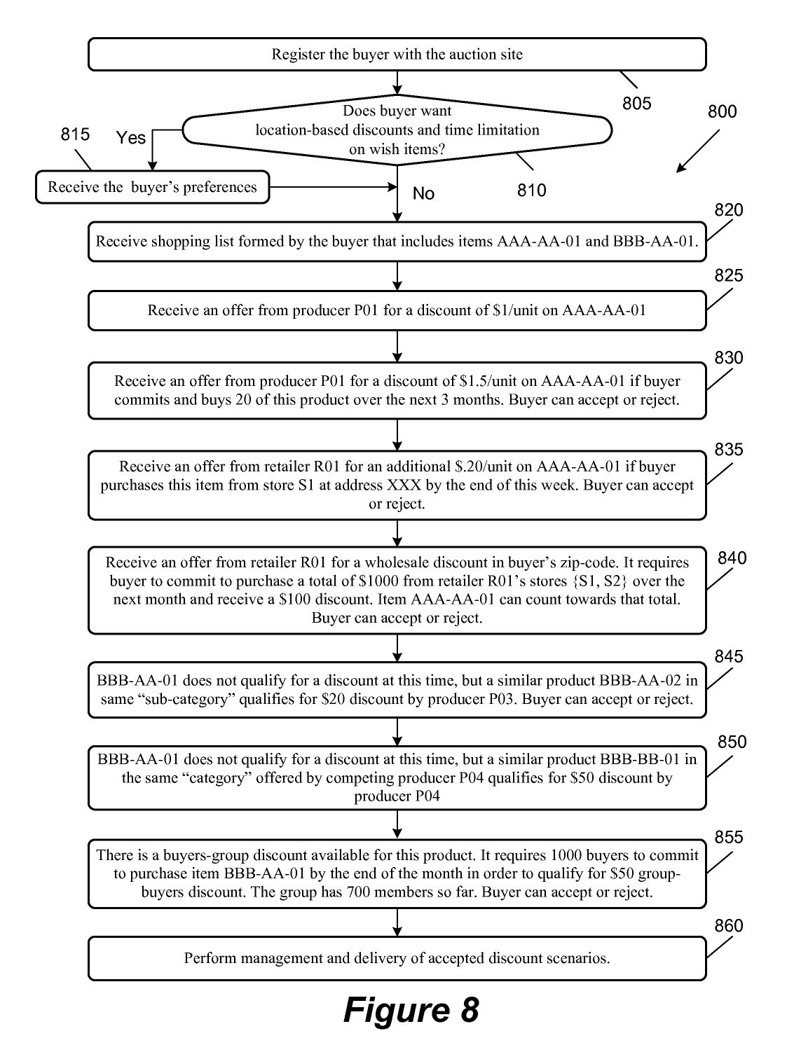

FIG. 8 conceptually illustrates an example of a process 800 for applicable discount scenarios and suggestions presented to a buyer in some embodiments of the invention. In this example the buyer enters the two items that are shown in FIG. 7 as mandatory shopping items in his/her shopping list. This process provides an example for usage scenarios described above for “Single-Buyer Online or Physical Store Shopping Cart (Necessary Items)” and “Group-Buyers Online or Physical Store Shopping Cart (Necessary Items)”, where a buyer receives single-buyer and group-buyer discounts. As shown, the process registers (at 805) the buyer with the auction site. The process then determines (at 810) whether the buyer want location-based discounts and time limitations on wish list (or shopping list) items. If no, the process proceeds to 820 which is described below. Otherwise, the process receives (at 815) the buyer's preferences.

The process then receives (at 820) shopping list formed by the user. The shopping list in this example includes items AAA-AA-01 and BBB-AA-01 (which were shown in FIG. 7). The process then receives offers from producers, retailers, and shippers for discounts. In this example, the process receives (at 825) an offer from producer P01 for a discount of $1/unit on AAA-AA-01. The process then receives (at 830) an offer from producer P01 for a discount of $1.5/unit on AAA-AA-01 if buyer commits and buys 20 of this product over the next 3 months. Buyer can accept or reject.

The process then receives (at 835) an offer from retailer R01 for an additional $0.20/unit on AAA-AA-01 if buyer purchases this item from store 51 at address XXX by the end of this week. Buyer can accept or reject. The process then receives (840) an offer from retailer R01 for a wholesale discount in buyer's zip-code. It requires buyer to commit to purchase a total of $1000 from retailer R01's stores {S1, S2} over the next month and receive a $100 discount. Item AAA-AA-01 can count towards that total. Buyer can accept or reject.

The process then determines (at 845) that item BBB-AA-01 does not qualify for a discount at this time, but a similar product BBB-AA-02 in same “sub-category” qualifies for $20 discount by producer P03. Buyer can accept or reject.

The process then determines (at 850) that item BBB-AA-01 does not qualify for a discount at this time, but a similar product BBB-BB-01 in the same “category” offered by competing producer P04 qualifies for $50 discount by producer P04.

The process then determines (at 855) that there is a buyers-group discount available for this product. It requires 1000 buyers to commit to purchase item BBB-AA-01 by the end of the month in order to qualify for $50 group-buyers discount. The group has 700 members so far. Buyer can accept or reject. The process performs (at 860) the management and delivery of accepted discount scenarios.

In FIG. 8 the auction system processes all applicable discount rules against the buyer's list and presents the buyer with single-buyer discounts, single-buyer wholes-sale discounts and group-buyer discounts. The example shows how some of the proposed discounts are constrained to certain store locations and time frames. The example demonstrates that the auction system identifies item replacement opportunities and presents them to the buyer. The process also outlines that the system identifies and suggests buyer grouping to the buyer (based on his/her list items and other buyers' databases).

One of ordinary skill in the art will recognize that process 800 shown in FIG. 8 is a conceptual representation of the applicable discount scenarios and suggestions presented to a buyer. Although the process is shown for an example scenario of two items in a shopping list of a buyer which receives offers from two retailers, the process can be generalized to any number of items and any number and types of sellers. The specific operations of process 800 may not be performed in the exact order shown and described. Furthermore, the specific operations of process 800 may not be performed in one continuous series of operations and different specific operations may be performed in different embodiments. Also, the process could be implemented using several sub-processes, or as part of a larger macro process.

### VI. Different Embodiments and Extensions of the Invention

A. Direct Reverse Auction Bidding

Some of the embodiments described are indirect forms of reverse auction since the sellers provide the auction site with discount items and discount rules and the auction site's discount processor processes the rules and notifies both the buyers and the sellers of the outcome at any given time. The sellers can then update their discount rules and send them to the auction site in order to be more competitive in the auction. This is an indirect form of bidding.

Other embodiments of the invention are direct form of bidding, where the sellers bid directly on the auction items. Thus, the system shown in FIG. 1 in these embodiments is modified where the sellers do not need to share their discount items and rules with the auction site. Instead the sellers bid directly on the auction lists and items. It is also possible that both indirect and direct forms of bidding co-exist together in the system. For example, for some categories of items like groceries the sellers share their discount rules and the indirect form of bidding is used, whereas for other categories such as electronics the sellers bid directly.

B. Online or Physical Store Group Buyers with Only One Seller

It was mentioned before that there are companies (such as Groupon™) that market fixed price deals from producers/retailers and as long as a minimum number of buyers commit to the deal then the deal is offered to the buyers. With such companies there is no bidding by different producers and furthermore the price of the deal is fixed beforehand by the producer/retailer. Thus, if there are not enough buyers the deal is not offered, and after a certain threshold the deal is offered at a pre-set price to everyone. There is, however, a market for companies that provide reduced pricing of such deals as more buyers sign up for the deal. For example, an example of such a deal on a gift card of company A is shown below, where a $100 gift card is offered at a discount and the discount amount increases as more buyer's sign up for the deal before a certain time limit expires:

If 1000<No of Buyers<=10000 gift card discount is 10%

If 10000<No of Buyers<=100000 Gift Card discount is 15%

If 100000<No of Buyers then Gift Card discount is 20%

Thus, even though this is not a reverse auction it does give additional incentives to buyers to propagate the deal further (using social networking or other means) even after the deal is offered in order to get even better discounts.

C. Informal Bidding

It was mentioned that companies such as Groupon™ bring deals from a seller to buyers. The approach in this invention brings groups of buyers to sellers. However, instead of storing discount rules of various sellers or having an actual reverse auction with sellers bidding, an alternative is to have an informal method where buyers just use the site to upload their shopping requests and form larger groups. The site can then approach one or more sellers and present them with the shopping list or the group shopping list and then present the best deal to the buyers. In other words, the potentially attractive group deals are identified and initiated by the system (by analyzing the items in all buyer's wish/shopping lists) and then presented/suggested to relevant sellers.

D. Mobile Payment of Cart Items in the Store

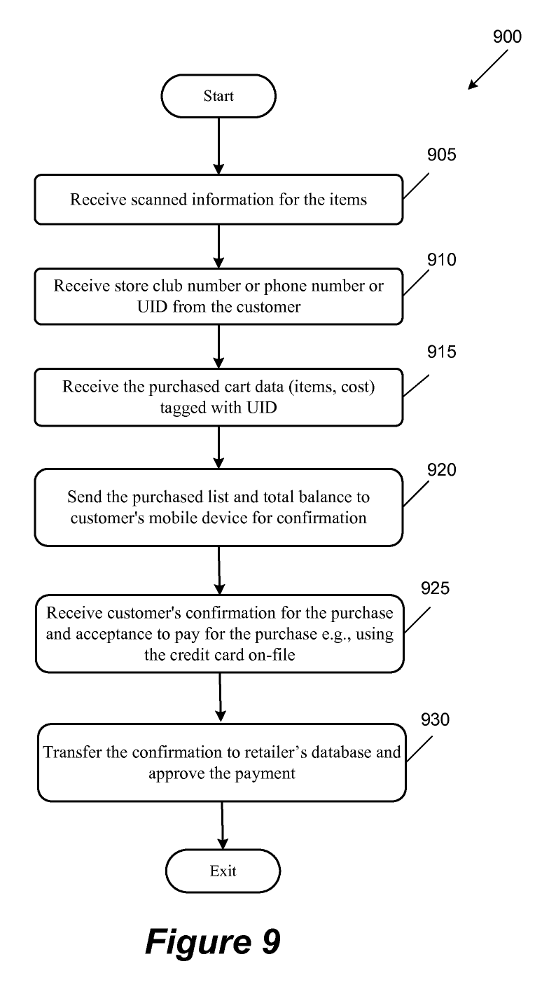

FIG. 9 conceptually illustrates a process 900 for making payments for a shopping/wish list through a mobile device in some embodiments of the invention. Process 900 in some embodiments is performed on one or more computing devices such as cash registers, servers, etc., of a seller. The process is utilized to receive information while a customer is in a physical retailer store. As shown, the process receives (at 905) scanned information for the items the customer wishes to purchase. For instance, when the customer visits a store, the store cashier scans all shopping items and process 900 receives the scanned information from the retail store's system.

Next, the process receives (at 910) an identification of the customer. In some embodiments, when the customer registers with the auction site, he/she can add his/her club number (or phone number) to his/her account with the system. Alternatively, the buyer requests a unique ID from the system in some embodiments. This ID uniquely identifies each buyer for participating sellers. The buyer is normally connected to the system through his/her mobile device. The customer enters his/her store club number (or phone number or unique ID) using a keypad at the store.

The process then receives (at 915) the customer's list and balance under the unique ID from the participating retailer system (e.g., after the retailer's database recognizes the customer and uploads the customer's list and balance). The process then sends (at 920) the list and balance to customer's mobile device. The process then receives (at 925) the customer's confirmation and acceptance to pay the balance through the customer's mobile device (e.g., the balance is then be charged to customer's credit card on-file). Upon customer's confirmation through mobile device, the process transfers (at 930) this payment approval to retailer's database and the customer's purchase is cleared by the cashier. Similar approach is deployed for online checkout except that the actions described by the retail store are done at the customer's computing or mobile device.

One of ordinary skill in the art will recognize that process 900 shown in FIG. 9 is a conceptual representation of operations for making payments for a shopping/wish list through a mobile device. The specific operations of process 900 may not be performed in the exact order shown and described. Furthermore, the specific operations of process 900 may not be performed in one continuous series of operations and different specific operations may be performed in different embodiments. Also, the process could be implemented using several sub-processes, or as part of a larger macro process.

E. Self-Service In-Store Checkout

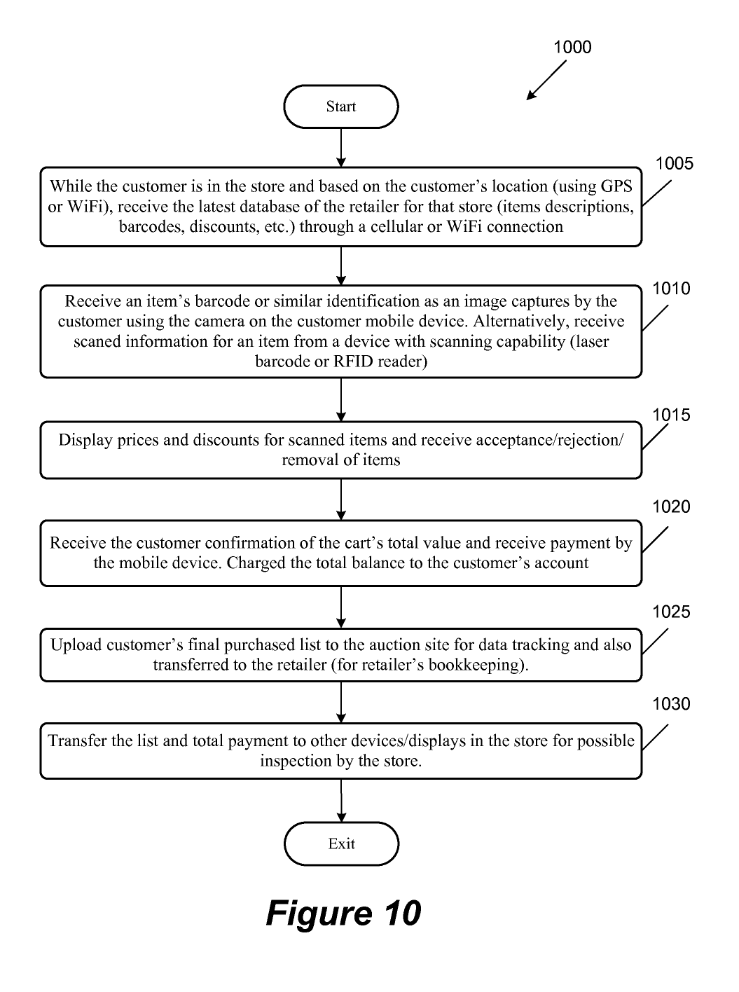

FIG. 10 conceptually illustrates a process 1000 performed by mobile devices of customers to enable the customers to use their mobile devices to scan items and pay for them in-store and bypass the in-store cashier in some embodiments of the invention. As shown, the process receives (at 1005) the latest information from the database of the retailer of the store. For instance, when a customer walks into a participating store, the store's product database (products, barcodes, and prices) is pushed (e.g., using cellular or WiFi connection) into customer's mobile device based on the customer's location (e.g., using location information utilizing GPS or WiFi).

The process then receives (at 1010) barcode or similar information regarding an item. For instance, the customer either uses his/her mobile device's camera or an external barcode scanner (to be attached to his/her mobile device) to scan the desired items in-store. As the customer scans items (through camera or a barcode scanner), the process sends the shopping list to the auction site to update his/her database in addition to displaying the list on his/her mobile device. The process receives scanned information for different items, provides (at 1015) the price and/or discount information to the customer (e.g., by displaying the information or playing the information on the mobile device speaker), and receives (at 1015) acceptance/rejection/removal of items from the customer.

The process then receives (at 1020) confirmation of the cart's total value from the customer and pays the balance. The balance is charged, e.g., to the customer credit card on-file or to the customer's account. The process then transfers (at 1025) the final shopping list and total balance is to the retailer so that the retailer can update its internal database accordingly. The process also optionally transfers (at 1030) the purchased list and the total payment to other devices and/or displays in the store for possible inspection by the store.

One of ordinary skill in the art will recognize that process 1000 shown in FIG. 10 is a conceptual representation of operations performed by mobile devices of a customers to enable the customers to use their mobile devices to scan items and pay for them in-store and bypass the in-store cashier. The specific operations of process 1000 may not be performed in the exact order shown and described. Furthermore, the specific operations of process 1000 may not be performed in one continuous series of operations and different specific operations may be performed in different embodiments. Also, the process could be implemented using several sub-processes, or as part of a larger macro process.

F. Notification Based on Usage History

Since a record of a buyer's purchase is available, some embodiments send notification (e.g., email/text-message/twitter/Facebook/voicemail) for future pending purchases. For instance, if the user has purchased a prescription from a pharmacy, the pharmacy can keep track of the expected date of usage completion of the prescription and then send a reminder to the buyer for refills. This re-usage scenario provides increasing recurring revenues for sellers.

### VII. Electronic System

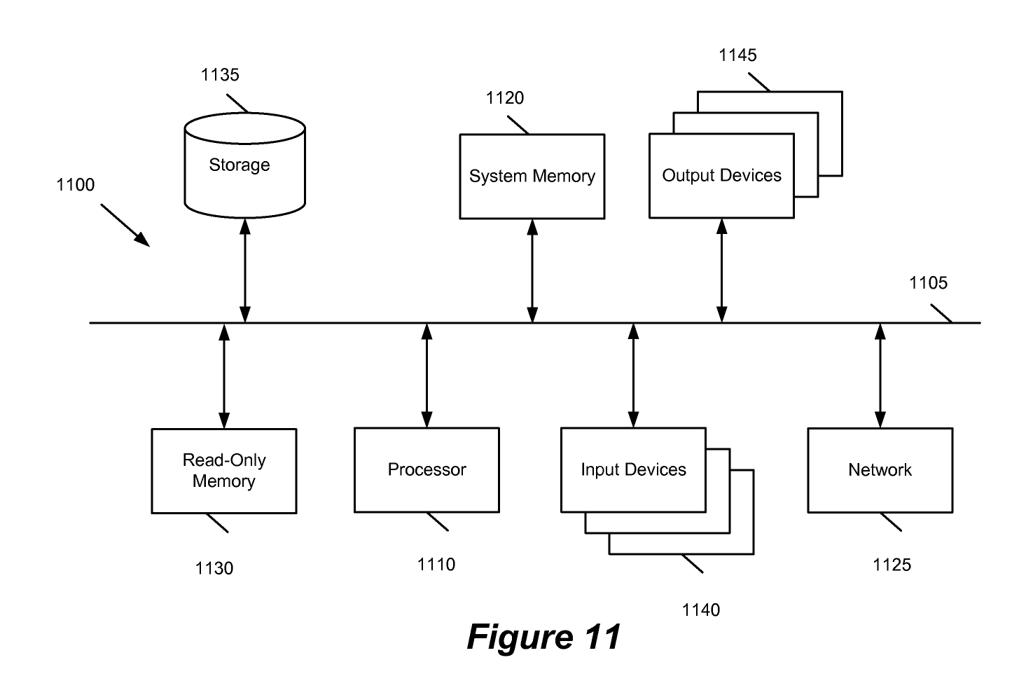

FIG. 11 conceptually illustrates an electronic system 1100 with which some embodiments of the invention are implemented. The electronic system 1100 may be a computer (e.g., a desktop computer, personal computer, tablet computer, server, etc.), phone, PDA, or any other sort of electronic or computing device. Such an electronic system includes various types of computer readable media and interfaces for various other types of computer readable media. Electronic system 1100 in some embodiments includes a bus 1105, processing unit(s) 1110, a system memory 1120, a network 1125, a read-only memory 1130, a permanent storage device 1135, input devices 1140, and output devices 1145.

The bus 1105 collectively represents all system, peripheral, and chipset buses that communicatively connect the numerous internal devices of the electronic system 1100. For instance, the bus 1105 communicatively connects the processing unit(s) 1110 with the read-only memory 1130, the system memory 1120, and the permanent storage device 1135.

From these various memory units, the processing unit(s) 1110 retrieves instructions to execute and data to process in order to execute the processes of the invention. The processing unit(s) may be a single processor or a multi-core processor in different embodiments.

The read-only-memory (ROM) 1130 stores static data and instructions that are needed by the processing unit(s) 1110 and other modules of the electronic system. The permanent storage device 1135, on the other hand, is a read-and-write memory device. This device is a non-volatile memory unit that stores instructions and data even when the electronic system 1100 is off. Some embodiments of the invention use a mass-storage device (such as a magnetic or optical disk and its corresponding disk drive) as the permanent storage device 1135.

Other embodiments use a removable storage device (such as a floppy disk, flash memory device, etc., and its corresponding disk drive) as the permanent storage device. Like the permanent storage device 1135, the system memory 1120 is a read-and-write memory device. However, unlike storage device 1135, the system memory 1120 is a volatile read-and-write memory, such a random access memory. The system memory 1120 stores some of the instructions and data that the processor needs at runtime. In some embodiments, the invention's processes are stored in the system memory 1120, the permanent storage device 1135, and/or the read-only memory 1130. For example, the various memory units include instructions for processing multimedia clips in accordance with some embodiments. From these various memory units, the processing unit(s) 1110 retrieves instructions to execute and data to process in order to execute the processes of some embodiments.

The bus 1105 also connects to the input and output devices 1140 and 1145. The input devices 1140 enable the user to communicate information and select commands to the electronic system. The input devices 1140 include alphanumeric keyboards and pointing devices (also called “cursor control devices”), cameras (e.g., webcams), microphones or similar devices for receiving voice commands, etc. The output devices 1145 display images generated by the electronic system or otherwise output data. The output devices 1145 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 11, bus 1105 also couples electronic system 1100 to a network 1125 through a network adapter (not shown). In this manner, the computer can be a part of a network of computers (such as a local area network (“LAN”), a wide area network (“WAN”), or an Intranet, or a network of networks, such as the Internet. Any or all components of electronic system 1100 may be used in conjunction with the invention.

Many of the above-described features and applications are implemented as software processes that are specified as a set of instructions recorded on a computer readable storage medium (also referred to as computer readable medium, machine readable medium, machine readable storage). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of this specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the invention has been described with reference to numerous specific details, one of ordinary skill in the art will recognize that the invention can be embodied in other specific forms without departing from the spirit of the invention. In addition, a number of the figures (e.g., FIGS. 2, 3, 8, 9, and 10) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

What is claimed is:

1. A method of performing an auction where a set of sellers bid on items in purchase lists of a plurality of buyers, each purchase list comprising a set of items a buyer intends to purchase in the auction, the method comprising:
receiving a purchase list comprising a set of items from a first buyer in the plurality of buyers;
analyzing purchase lists of a set of buyers in the plurality of buyers to identify items related to the items in the set of items in the purchase list of the first buyer;
suggesting a replacement first item to an existing second item in the purchase list of a second buyer in the plurality of buyers based on the analysis of the purchase lists of the set of buyers, the replacement item generating a higher discount in the auction than a discount associated with the existing item;
receiving a request to replace the existing item with the suggested item in the purchase list of the second buyer; and
performing the auction based on the received request.

2. The method of claim 1, wherein suggesting the replacement item comprises determining that a larger number of buyers in the set of buyers have included the first item in their purchase lists than the second item.

3. The method of claim 1, wherein suggesting the replacement item comprises determining that at least one seller participating in the auction is offering a higher discount for selling a particular quantity of the first item than the second item.

4. The method of claim 1 further comprising, prior to analyzing the purchase lists of the set of buyers, receiving a maximum price from the second buyer for the second item,
wherein suggesting the replacement first item comprises determining that the replacement first item has a higher probability of satisfying said maximum price in the auction than the second item.

5. The method of claim 4 further comprising:
calculating a suggested initial price for the second item; and
displaying the suggested initial price to the second buyer prior to receiving the maximum price from the second buyer for the second item.

6. The method of claim 1, wherein the first and second items are in a same category of items from two different sellers participating in the auction.

7. The method of claim 1, wherein the first and second items are in a different category of items available for the auction from a same seller.

8. The method of claim 1 further comprising:
receiving discount rules from a particular seller for a set of items sold by the particular seller in the auction;
receiving a change in a purchase list of a particular buyer that includes an item from the set of items sold by the seller in the auction;
informing the seller of the received change from the particular buyer; and
receiving a change in said discount rules from the seller based on the received change from the particular buyer.

9. The method of claim 8, wherein the received change in the purchase list of the particular buyer comprises one of a change in a quantity of the item that the particular buyer is willing to buy, a maximum price set by the particular buyer for the item, and an addition of the item in the particular buyer purchase list.

10. The method of claim 1 further comprising:
determining a total quantity of a particular item that the purchase lists of the plurality of buyers;
calculating a group discount based on the total quantity of the particular item in the purchase lists of the plurality of buyers; and
offering the group discount for the particular item to all buyers in the plurality of buyers.

11. The method of claim 1, wherein the second buyer is different than the first buyer, wherein at least one item in the purchase lists of the first and second buyers include a common time or location constraint.

12. The method of claim 1, wherein the second buyer and the first buyer are a same buyer.

13. A method of performing an auction where a set of sellers bid on items in purchase lists of a plurality of buyers, each purchase list comprising a set of items a buyer intends to purchase in the auction, the method comprising:
receiving a first purchase list comprising a set of items from a first buyer in the plurality of buyers;
receiving, from the first buyer, an identification of a set of users to join the auction;
sending an invitation to the identified set of users to join the auction, the invitation comprising information about a first item in the first purchase list; and
registering at least a particular user from the identified set of users as a second buyer in the auction;
receiving an identification of a second item to include in a second purchase list of the second buyer; and
performing the auction based on the first and second purchase lists.

14. The method of claim 13, wherein the first and second items are a same item.

15. The method of claim 13, wherein the first and second items are in a same category of items from two different sellers participating in the auction.

16. The method of claim 13, wherein the first and second items are in a different category of items available for the auction from a same seller.

17. The method of claim 13, wherein the first and second purchase lists are a same common purchase list utilized by both the first and second buyers, the method further comprising:
assigning a unique identifier to each of the first and second buyers;
tagging each item entered by the first buyer in the common purchase list with the unique identifier of the first buyer; and
tagging each item entered by the second buyer in the common purchase list with the unique identifier of the second buyer.

18. The method of claim 13, wherein the first purchase list is a private purchase list that limits the invitation from the first buyer to a controlled group of users, wherein the controlled group of users comprises said set of users identified by the first buyer to join the auction.

19. The method of claim 13, wherein the set of users is a first set of users, the method further comprising sending invitations to a second set of users to join the auction based on a purchasing profile of the second set of users and one or more currently being auctioned.

20. The method of claim 19, wherein the purchasing profile of the second set of users comprises one of a purchasing history, items in purchase lists of the second set of users in prior auctions, time constraints in the purchase lists of the second set of users in prior auctions, and location constraints in purchase lists of the second set of users in prior auctions.
